(19) United States
(12) Patent Application Publication
(10) Pub. No.: US 2009/0157312 A1
(43) Pub. Date: Jun. 18, 2009

(54) SOCIAL NETWORK BASED ROUTES

(75) Inventors: Neil W. Black, Seattle, WA (US); John C. Krumm, Redmond, WA (US); Ruston Panabaker, Redmond, WA (US); Jeffrey D. Couckuyt, Bothell, WA (US); Ivan J. Tashev, Kirkland, WA (US); Michael Lewis Seltzer, Seattle, WA (US)

Correspondence Address: AMIN, TUROCY & CALVIN, LLP, 127 Public Square, 57th Floor, Key Tower, CLEVELAND, OH, 44114, US

(73) Assignee: MICROSOFT CORPORATION, Redmond, WA (US)

(21) Appl. No.: 11/957,167

(22) Filed: Dec. 14, 2007

(51) Int. Cl. G01C 21/30

(52) U.S. Cl. 701/210

(57) ABSTRACT

A route can be generated that considers social networking information. For instance, a user can be traveling on vacation and individuals designated by a user can add comments to a route. In addition, previous journeys of user contacts can be evaluated and based upon the evaluation results, portions of a route can be constructed. Further functionality can include transferring rewards between parties for disclosing information as well as posting information on various social networking profiles.

### CROSS-REFERENCE

This application relates to U.S. Patent Application draft with Attorney Docket No. MSFTP2086US entitled “ROUTE MONETIZATION”.

This application relates to U.S. Patent Application draft with Attorney Docket No. MSFTP2087US entitled “FEDERATED ROUTE PRODUCTION”.

This application relates to U.S. Patent Application draft with Attorney Docket No. MSFTP2088US entitled “DESTINATION AUCTIONED THROUGH BUSINESS OF INTEREST”.

This application relates to U.S. Patent Application draft with Attorney Docket No. MSFTP2089US entitled “GENERATIONAL INTELLIGENT NAVIGATION SYNCHRONIZATION OR UPDATE”.

This application relates to U.S. Patent Application draft with Attorney Docket No. MSFTP2091US entitled “ROUTE TRANSFER BETWEEN DEVICES”.

This application relates to U.S. Patent Application draft with Attorney Docket No. MSFTP2092US entitled “ADDITIONAL CONTENT BASED ON INTENDED TRAVEL DESTINATION”.

This application relates to U.S. Patent Application draft with Attorney Docket No. MSFTP2093US entitled “AUTOMATIC SPLICES FOR TARGETED ADVERTISEMENTS”.

This application relates to U.S. Patent Application draft with Attorney Docket No. MSFTP2094US entitled “PEDESTRIAN ROUTE PRODUCTION”.

This application relates to U.S. Patent Application draft with Attorney Docket No. MSFTP2095US entitled “ROUTE GENERATION BASED UPON ACTIVITY CRITERIA”.

### TECHNICAL FIELD

The subject specification relates generally to route production and in particular to producing a route in conjunction with social networking information.

### BACKGROUND

Computer-driven route planning applications are utilized to aid users in locating points of interest, such as particular buildings, addresses, and the like. Additionally, in several existent commercial applications, users can vary a zoom level, thereby enabling variation of context and detail as a zoom level of a map is altered. For example, as a user zooms in on a particular location, details such as names of local roads, identification and location of police and fire stations, identification and location of public services, such as libraries, museums, and the like can be provided to the user. When zooming out, the user can glean information from the map such as location of the point of interest within a municipality, state/providence, and/or country, proximity of the point of interest to major freeways, proximity of the point of interest to a specific city, and the like.

Furthermore, conventional computer-implemented mapping applications often include route-planning applications that can be utilized to provide users with directions between different locations. Pursuant to an example, a user can provide a route planning application with a beginning point of travel and an end point of travel (e.g., beginning and ending addresses). The route planning application can include or utilize representations of roads and intersections and one or more algorithms to output a suggested route of travel. These algorithms can output routes depending upon user-selected parameters. For instance, a commercial route planning application can include a check box that enables a user to specify that she desires to avoid highways. Similarly, a user can inform the route planning application that she wishes to travel on a shortest route or a route that takes a least amount of time (as determined by underlying algorithms). Over the last several years, individuals have grown to rely increasingly on route planning applications to aid them in everything from locating a friend's house to planning cross-country road trips.

### SUMMARY

The following discloses a simplified summary of the specification in order to provide a basic understanding of some aspects of the specification. This summary is not an extensive overview of the specification. It is intended to neither identify key or critical elements of the specification nor delineate the scope of the specification. Its sole purpose is to disclose some concepts of the specification in a simplified form as a prelude to the more detailed description that is disclosed later.

Social networking Internet sites (networking sites) are a popular medium that allows individuals to communicate with friends/contacts as well as meet new people. Many networking sites allow people to send electronic messages, post comments, upload music, search for individuals with related interests, etc. Extensions of social networking sites allow people to buy/sell goods or services, gain academic assistance, and the like. However, common networking sites do not integrate benefits of producing a route for a user and visa versa (e.g., route generation systems commonly do not integrate social networking site information in route production).

The disclosed innovation integrates aspects of social networking in route production. An obtainment component gathers social networking information and a fabrication component produces a route based upon the gathered information, such as taking a user to a site visited by many individuals with a friend relationship on a networking site. Various features can be included in the disclosed innovation to increase functionality. For instance, a route can be produced that allows a user to increase content for placement upon a social network, such as taking a user past landmarks that would encourage the user to take pictures, the pictures can be uploaded upon a social network profile.

Unexpected results can be created through integration of social networking sites and route production. For instance, a user can experience a more enjoyable route if friends can add content related to the route; commonly, it would be expected that adding content to a route would confuse a user. Moreover, a large number of individuals studying route generation consider social networking to be a ‘fad’ and use of social networking toward route production has been virtually ignored by industry experts.

The following description and the annexed drawings set forth certain illustrative aspects of the specification. These aspects are indicative, however, of but a few of the various ways in which the principles of the specification can be employed. Other advantages and novel features of the specification will become apparent from the following detailed description of the specification when considered in conjunction with the drawings.

### BRIEF DESCRIPTION OF THE DRAWINGS

FIG. 1 illustrates a representative system for producing a direction set based upon social networking information in accordance with an aspect of the subject specification.

FIG. 2 illustrates a representative system for producing a direction set based upon social networking information with a detailed obtainment component in accordance with an aspect of the subject specification.

FIG. 3 illustrates a representative system for producing a direction set based upon social networking information with a detailed fabrication component in accordance with an aspect of the subject specification.

FIG. 4 illustrates a representative system for producing a direction set based upon social networking information with a detailed interaction component and disclosure component in accordance with an aspect of the subject specification.

FIG. 5 illustrates a representative presentment that can be shown by a disclosure component in accordance with an aspect of the subject specification.

FIG. 6 illustrates a representative feedback processing methodology in accordance with an aspect of the subject specification.

FIG. 7 illustrates a representative route publishing methodology in accordance with an aspect of the subject specification.

FIG. 8 illustrates a representative feedback collection methodology in accordance with an aspect of the subject specification.

FIG. 9 illustrates an example of a schematic block diagram of a computing environment in accordance with the subject specification.

FIG. 10 illustrates an example of a block diagram of a computer operable to execute the disclosed architecture.

### DETAILED DESCRIPTION

The claimed subject matter is now described with reference to the drawings, wherein like reference numerals are used to refer to like elements throughout. In the following description, for purposes of explanation, numerous specific details are set forth in order to provide a thorough understanding of the claimed subject matter. It can be evident, however, that the claimed subject matter can be practiced without these specific details. In other instances, well-known structures and devices are shown in block diagram form in order to facilitate describing the claimed subject matter.

As used in this application, the terms “component,” “module,” “system,” “interface,” or the like are generally intended to refer to a computer-related entity, either hardware, a combination of hardware and software, software, or software in execution. For example, a component can be, but is not limited to being, a process running on a processor, a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. As another example, an interface can include I/O components as well as associated processor, application, and/or API components.

Furthermore, the claimed subject matter can be implemented as a method, apparatus, or article of manufacture using standard programming and/or engineering techniques to produce software, firmware, hardware, or any combination thereof to control a computer to implement the disclosed subject matter. The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications can be made to this configuration without departing from the scope or spirit of the claimed subject matter.

Moreover, the word “exemplary” is used herein to mean serving as an example, instance, or illustration. Any aspect or design described herein as “exemplary” is not necessarily to be construed as preferred or advantageous over other aspects or designs. Rather, use of the word exemplary is intended to disclose concepts in a concrete fashion. As used in this application, the term “or” is intended to mean an inclusive “or” rather than an exclusive “or”. That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. In addition, the articles “a” and “an” as used in this application and the appended claims should generally be construed to mean “one or more” unless specified otherwise or clear from context to be directed to a singular form. It is to be appreciated that inferences or determinations disclosed in the subject specification can be practiced through use of artificial intelligence techniques.

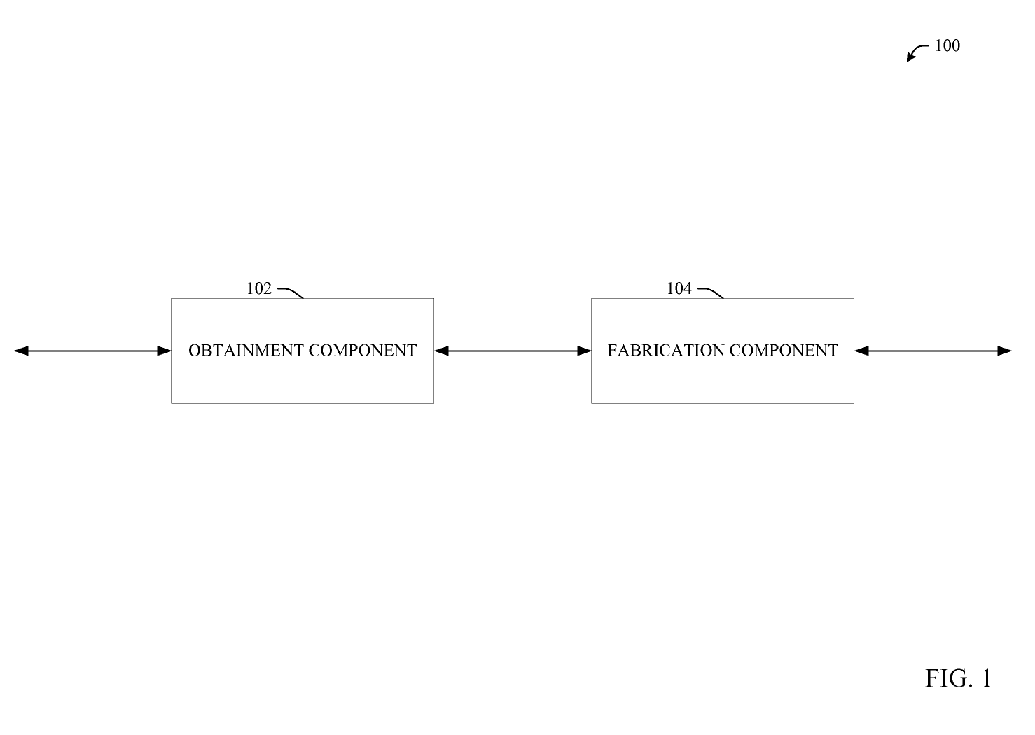

Now referring to FIG. 1, an example system 100 is disclosed for producing a route based upon social network information. Social networking allows communities of individuals or entities to group together and share information, commonly concerning personal matters. A relatively large number of data network sites (e.g., Internet sites) allow users to create personal profiles that link with one another to create the social network. Different relationships can be defined in the social network, such as a ‘contact’ relationship, ‘friend’ relationship, etc. Information can be shared between users, such as a user posting a comment on a profile of a friend, where the comment becomes part of the profile.

Various amounts of social networking information can be used in route production. An obtainment component 102 can collect information that concerns a user (e.g., a profile of a user) upon a social network (e.g., the network can include friends, relatives, colleagues, co-workers, etc.). The collected information can transfer to a fabrication component 104 that produces a route based at least in part upon the collected social network information of the user. Route production can include modifying a route, creating a route, adding information to a route, etc.

According to one embodiment, information is gathered to modify an existing route. For instance, a user can be traveling through a major city while on vacation and a generated route that takes a user past various sites can be posted on a social network profile of the user. Friends of the user can post comments on the route and the obtainment component 102 can collect the comments. A friend can post that an interesting museum is near a path along the generated route. The fabrication component 104 can process the comment (e.g., infer that since the poster is a friend that the user is likely to have an interest in the museum) and modify the route such that the user travels to the museum. This can be done with user approval, at a request of the user, automatically, and the like.

The system 100 can be implemented in order to generate a new route for a user. A user can make a request to the system 100 to travel from her home to a library to perform research; however, the request can be general and not specify a particular library to use. The obtainment component 102 can collect libraries that have been visited by user friends on the social network, review comments users have posted about libraries (e.g., from friends, general reviews, and the like), etc. Based upon the collected information, the fabrication component 104 can select a library and create a route for the user.

Moreover, the fabrication component 104 can produce a route that is the same as an initial route; however, the route is produced with added information. In an illustrative example, a user can be traveling along a walking route that is posted on a social networking page. A guest can add a comment that a bakery sells delicious cookies that is located along the walking route and the comment can be extracted by the obtainment component 102. The fabrication component 104 can add the comment to the walking route such that the comment is disclosed with the route at an appropriate time, such as when the user is near the bakery. The fabrication component 104 can produce the route in order to increase an amount of content for placement upon the social network or produce an improved route (e.g., makes a route safer based upon user comments of a dangerous area, produce the route in order to increase an amount of content for placement upon the social network, and the like).

While aspects of the subject specification discuss social networks where a user has a profile and a group of contacts, it is to be appreciated other implementations can be practiced. For instance, routes between an origin/destination can be obtained by observing other drivers who travel between a similar origin and destination. Using a global positioning device, at least one component of the subject specification can collect routes taken by observed drivers and this information can be aggregated and used to produce a route. Thus in the disclosed instance, the social network can be drivers who travel between similar start/end points, even if the drivers are unknown to a user. Routes traveled by a relatively large group of people can be inherently considered ‘good’ routes even if not proposed by a routing engine.

Moreover, routes taken by people in a user's social network can be used to generate routes that have a relatively high likelihood of being followed by the user. For example, a routing system can initially generate a ‘shortest’ route that takes Road A; if the system 100 determines that people in the user's social network usually take Road B (e.g., because in practice Road B is less congested), then a route is produced that includes Road B.

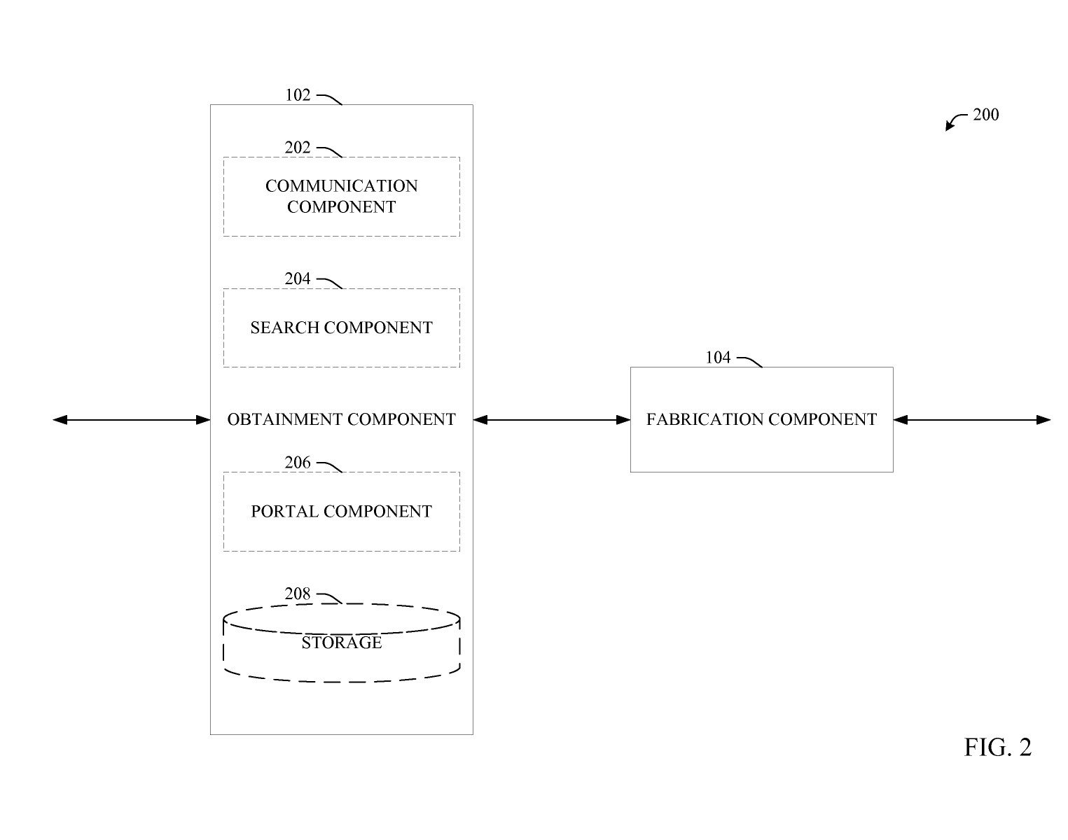

Now referring to FIG. 2, an example system 200 is disclosed for producing a route based upon social network information with a representative expanded obtainment component 102. A communication component 202 can engage with other devices to transfer information, such as to send a request for information, receiving information from an auxiliary source (e.g., social networking site host), etc. Operation can take place wirelessly, in a hard-wired manner, employment of security technology (e.g., encryption), etc. The information transfer can be active (e.g., query/response) or passive (e.g., a social network site host broadcasts information and the communication component 202 selects the relevant portion). Moreover, the communication component 202 can utilize various protective features, such as performing a virus scan on collected data and blocking information that is positive for a virus.

To engage at least one source (e.g., auxiliary source, such as a social networking site host), a search component 204 can be employed to locate a source that provides information that can be obtained. A source can be a database server, an airway transmission, in incoming electronic message, etc. The search component 204 can retain addresses (e.g., Internet Protocol addresses) of locations that have a history of providing quality information. Moreover, the search component 204 can identify low quality sources (e.g., sources that do not provide much information that is used in route generation) and block information obtainment for such identified sources. The search component 204 can function to extract information from a source, make a copy of information, etc.

A user can input instructions into the systems as to multiple profiles that she retains in different social networking sites. A portal component 206 can directly interface with at least one social networking site and enable integrated communication with the sites. As a comment is made upon a profile, the portal component 206 can automatically make a copy of the comment and retain the comment is storage 208. Moreover, comments made upon a profile of one social networking site can populate upon profiles of other social networking sites.

Different pieces of information, such as obtained information, component operating instructions (e.g., of the search component 204), source location, an original route, etc. can be held on storage 208. Storage 208 can arrange in a number of different configurations, including as random access memory, battery-backed memory, hard disk, magnetic tape, etc. Various features can be implemented upon storage 208, such as compression and automatic back up (e.g., use of a Redundant Array of Independent Drives configuration). Information collected by the obtainment component 102 can be processed by a fabrication component 104 that produces a route based at least in part upon the collected social network information of the user.

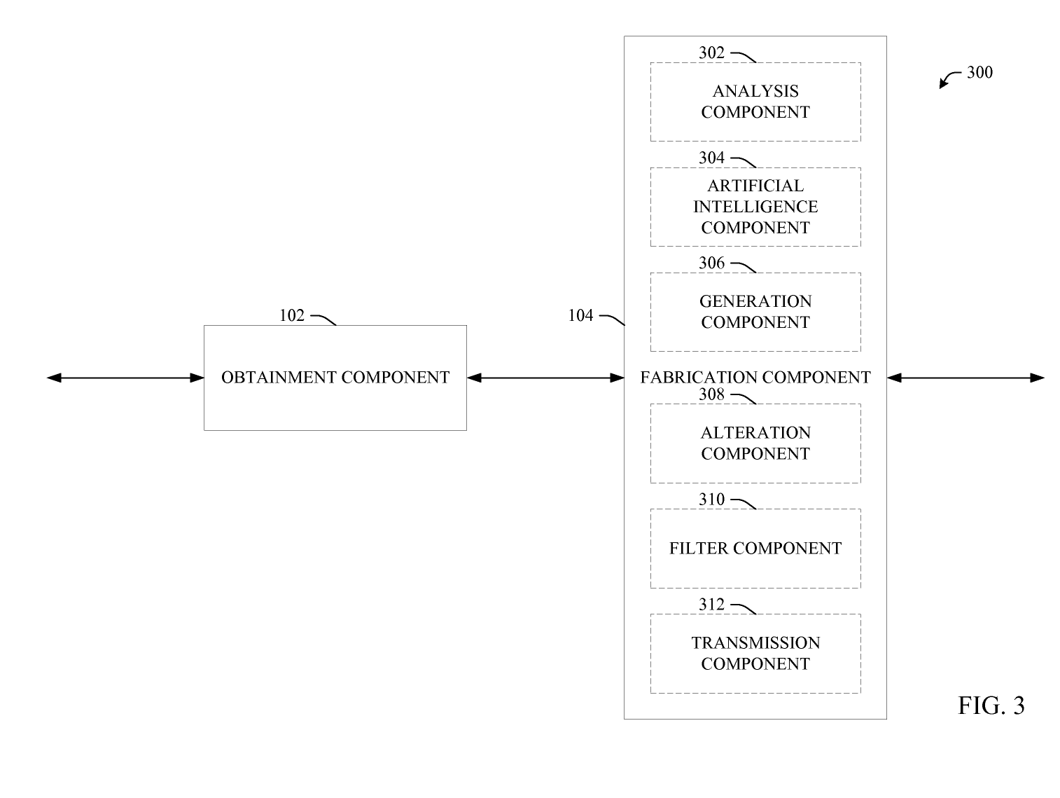

Now referring to FIG. 3, an example system 300 is disclosed for producing a route based upon social network information with a representative expanded fabrication component 104. An obtainment component 102 collects information that concerns a user upon a social network. A fabrication component 104 can produce a route based at least in part upon the collected social network information of the user.

Collected information can be evaluated by an analysis component 302 and relevant results can be produced. For instance, a friend of the user can have a comment that states ‘I love sandwiches from Joe's Deli.’ The analysis component 302 can employ the search component 204 of FIG. 2 to determine locations of establishments named ‘Joe's Deli’ as well as establishments with similar names (e.g., ‘Joseph's Deli’ which many refer to as ‘Joe's Deli’). Once located, the analysis component 302 can infer if a discovered ‘Joe's Deli’ is the same deli as suggested by the friend. The fabrication component 104 can use the result (e.g., a deli liked by a friend) to generate a route when a user asks for a route to somewhere to eat, but does not specify where he would like to dine.

Various inferences or determinations that occur in relation to the obtainment component 102 or fabrication component 104 can be processed by an artificial intelligence component 304. For instance, the artificial intelligence component 304 can infer that a user would enjoy similar locations that a person designated on as a contact on a social networking site would enjoy. Moreover, the artificial intelligence component 304 can make different determinations, such as determining an order of friends that can be used in selecting information (e.g., information from a higher ranked friend can be given more weight then information from other friends). The artificial intelligence component 304 can infer aspects of routes of social network contacts and use an inference result to produce a new route. For example, if other drivers traveling between a first shopping mall and a second shopping mall avoid Main Street, then an inference can be made that Main Street is a poor path choice and a route is produced that does not include Main Street.

Artificial intelligence component 304 can employ one of numerous methodologies for learning from data and then drawing inferences and/or making determinations related to applying a service (e.g., Hidden Markov Models (HMMs) and related prototypical dependency models, more general probabilistic graphical models, such as Bayesian networks, e.g., created by structure search using a Bayesian model score or approximation, linear classifiers, such as support vector machines (SVMs), non-linear classifiers, such as methods referred to as “neural network” methodologies, fuzzy logic methodologies, and other approaches that perform data fusion, etc.) in accordance with implementing various automated aspects described herein. Methods also include methods for the capture of logical relationships such as theorem provers or more heuristic rule-based expert systems.

Based upon the collected information, evaluation results, relevant determinations or inferences, etc., a new route can be produced by a generation component 306. The generation component can access a mapping database and determine paths that should be combined to create a direction set. Various features can integrate with the generation component 306 to enhance functionality. The generation component 306 can predict an intended destination of a user and create a route to the predicted intended destination. For instance, a user can post a comment on her social networking profile that she is planning to attend an opera and the generation component can predict (e.g., through inference) that she is going to travel to an opera house previously visited by her social network contacts.

An existing route can be changed through use of an alteration component 308. The obtainment component 102 can collect information created by an individual associated with the social network that concerns the route. For instance, a friend of a user can post a comment on a route created by a generation component 306 (e.g., that is posted on a user profile) that a route portion is dangerous. The alteration component 308 can modify the route based upon the gathered information by an individual associated with the social network, the fabrication component 104 produces the modified route (e.g., outputs the route). In an example illustration, the alteration component 308 can verify safety characteristics of the identified portion, determine a replacement portion that is safer, and modify the route to use the replacement portion as opposed to the identified portion. The alteration component 308 can modify the route to produce an improved route (e.g., makes a route safer based upon user comments of a dangerous area, produce the route in order to increase an amount of content for placement upon the social network, and the like).

When a route is posted on a social networking site, the obtainment component 102 can gather feedback information. The obtainment component 102 can function as a means for collecting feedback that concerns a route from members of the social network. Based upon gathered feedback, the alteration component 308 can modify the route. Thus, the alteration component 308 can implement as a means for altering the route as a function of the collected feedback.

A user or a social network contact can be presented a specialized interface tailored to facilitate data addition toward a route. According to one embodiment, a map-based program such as a data network site (e.g., Internet site) allows people to add various amounts of information to a route. In one instance, a suggestion that the user should stop at a shop along her route can be inputted upon the interface (e.g., the interface is produced by at least one component disclosed in the subject specification), associated with a map display, and presented to the user.

It is possible that a relatively large amount of information can be gathered through the obtainment component 102 and it can be cumbersome to present all information to a user (e.g., all comments). A filter component 310 can ascertain information (e.g., social network information) that is presented to a user. A friend can state that there is a great stop to purchase breakfast—if the user is traveling through an area at an evening time, then the information is likely of little value and the filter component 310 can block the information from being disclosed.

A route processed by the generation component 306, alteration component 308, or filter component 310 can be produced by the fabrication component 104. A transmission component 312 can emit metadata (e.g., the route, route comments, etc.) of the route to a host of the social network, the host posts at least a portion of the metadata upon the social network (e.g., a user profile).

In one illustration, the generation component 306 can produce a route and the route can be posted on a social network profile through use of the transmission component 312. A friend can comment on the route, the obtainment component 102 can access the comment, and the comment is evaluated by the analysis component 302 through utilization of artificial intelligence component 304. Based on the comment, the alteration component 308 can change the route in accordance with the comment. The route can be presented to the user, yet the comment is not deemed valuable to be presented to the user by the filter component 310.

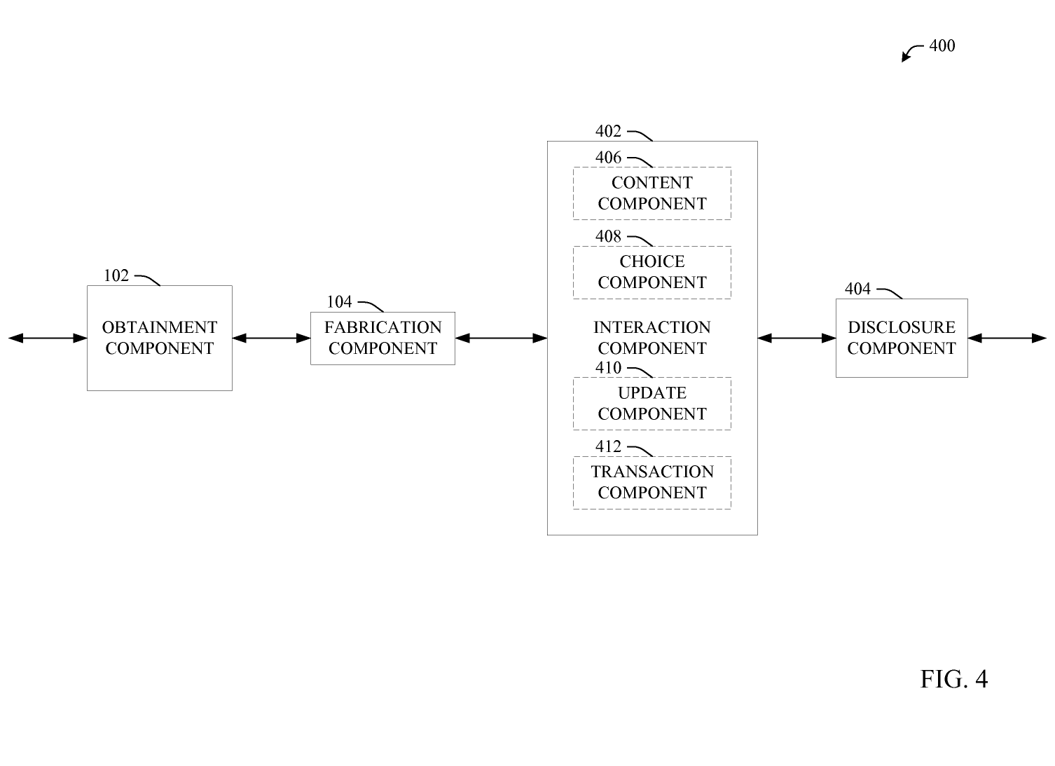

Now referring to FIG. 4, an example system 400 is disclosed for producing a route based upon social network information with a representative expanded interaction component 402 and disclosure component 404. An obtainment component 102 collects information that concerns a user upon a social network. A fabrication component 104 that produces a route based at least in part upon the collected social network information of the user. While the obtainment component 102 and fabrication component 104 commonly interact with a social network, it is to be appreciated that a social network can include multiple social networking sites, where a user has independent profiles on the different sites. Additionally, non-social networking information as well as social networking information can be used together by the obtainment component 102 or fabrication component 104

Moreover, the fabrication component 104 can produce a route based upon travel of at least one social network contact of the user. The obtainment component 102 can evaluate routes traveled by friends of the user. Based at least in part upon previous travel of friends, a route can be constructed. For instance, if a number of friends have taken a particular nature walk, then an inference can be made that the user would enjoy the nature walk and the route can be produced that includes the nature walk (e.g., copied from a profile of a friend by the fabrication component 104 and then produced to the user).

An interaction component 402 can enable members of a social network to interrelate with a user or a user's route. A content component 406 can gather data associated with the route while the user travels along the route. For instance, a user can be traveling on vacation and pass by a number of public cameras where the user poses for a picture and the content component 406 can retain copies of the pictures.

Since a relatively large amount of data can be gathered, a choice component 408 can select at least a portion of gathered data to be posted on a profile of the user, the profile is associated with the social network. For example, the choice component 408 can evaluate profiles of friends of the user and determine that people of a community have a history of positing pictures of her standing in front of famous landmarks. The choice component 408 can evaluate photograph copies retained by the content component 408 and determine pictures where the user is with a landmark (e.g., famous or well-known location).

A message can be prepared to be sent by an update component 410 that instructs that at least a portion of selected gathered data be posted upon the profile of the user. For example, the update component 410 can retain a copy of a selected picture and attach the picture to instruction on how to post the picture (e.g., the picture is in color, but should be posted in black-and-white). The update component 410 can communicate with a host (e.g., through the communication component 202 of FIG. 2) of a social networking site. For instance, if picture is considered inappropriate by a host, then the update component 410 can receive a message from the host stating such and the update component 410 can instruct the choice component 408 to make a different selection.

A party can request payment for services rendered or to be completed, such as providing information, posting data, generating or altering a route, etc. The transaction component 412 can perform a reward (e.g., financial, non-financial, etc.) function based upon route production or information collection. The transaction component 412 can perform actions to meet constraints, such as debiting a user account and crediting a provider account. While fiscal amounts are commonly transacted, it is to be appreciated that other commodities can be exchanged, such as coupons, meeting of contractual obligations (e.g., canceling of a task to be performed), tax credits, etc. The transaction component 412 can augment a commercial detail (e.g., advertisement for a product, coupon, etc.) upon a route and an advertisement hosting site can be compensated based upon a user response (e.g., a user purchases the product).

Moreover, a reward function can take place in relation to user response to a commercial detail. For example, an advertisement can be played that a user should stop at a highway exit for a cup of coffee. If the user takes the exit, buys the cup of coffee, buys a different item, etc., then payments of varying amounts can be made to an advertisement hosting service.

A disclosure component 404 can provide the route to a user (e.g., operating a vehicle passenger or operator, as a pedestrian, etc.). A non-exhaustive list of disclosure components include a display screen, touch screen, speaker system, virtual reality environment, Braille production system, printer, etc. In addition, the disclosure component 404 can present information in multiple formats, such as showing a video with audio capabilities. Moreover, the disclosure component 404, as well as other components disclosed in the subject specification can implement upon a personal electronic device (e.g., cellular telephone, personal digital assistant, etc.), upon a vehicle (e.g., automobile, motorcycle, bicycle, airplane, helicopter, motorboat, self-balancing transportation device, etc.), etc.

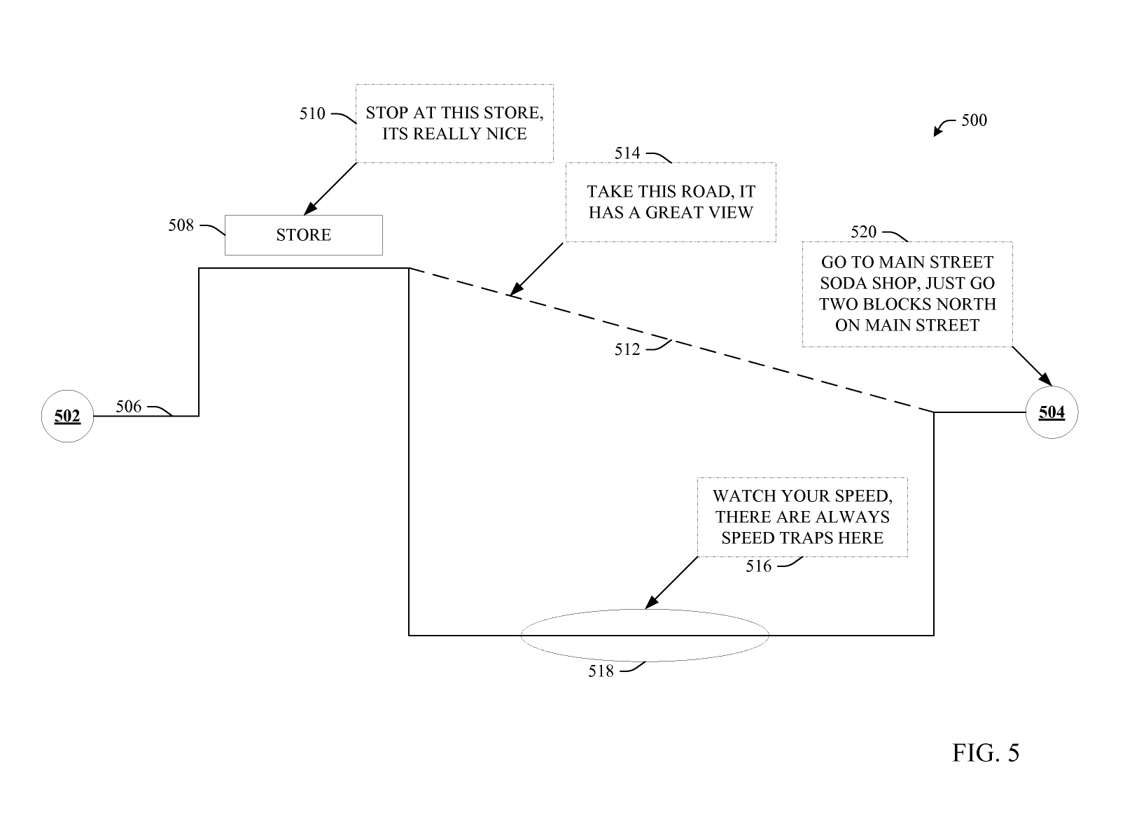

Now referring to FIG. 5, an example presentation 500 is disclosed as can be produced by the fabrication component 104 of FIG. 1 and presented on the disclosure component 404 of FIG. 4. Commonly, a user has a desire to travel between a starting point 502 and a destination point 504. Based on this information as well as information related to a social network, a route 506 can be constructed.

The obtainment component 102 of FIG. 1 can gather information concerning a route posted by members of a social network. For instance, a route can configure to take a user past a store 508 A friend can post a comment 510 about the store 508 relating to store quality. The filter component 310 of FIG. 3 can determine that the comment 510 should be presented to the user and arrange the comment 510 for presentment (e.g., establish the comment 510 should be placed in above and to the right of the store 508).

While a route can be generated taking into account data from multiple users, a comment from a friend can be considered more valuable. For example, the fabrication component 104 of FIG. 1 can suggest a path while a user suggests a different path. The user suggested path 512 can be displayed in addition to a produced route, the suggested path can be provided a different context (e.g., be a dashed line while the produced route is shown as a solid line), and an auxiliary comment 514 can be added.

Additionally, user metadata can be shown regarding to route portions. For instance, a friend can signify that an area has a relatively high likelihood of producing traffic tickets through comment 516. While a database can show that a particular road has no greater likelihood than another road of producing traffic tickets, a user can still consider recommendations of the friend as valuable information. Therefore, the comment 516 can be posted as well as a highlight 518 of a designated area. Examples of other information that can be added include road closures due to construction or accidents. According to another embodiment, aspects of the subject specification can be used to add new roads to a map (e.g., such as when a new housing development or shopping center is built).

While many aspects of the subject specification has disclosed information from personal contacts known as ‘friends’ concerning a route, it is to be appreciated that other information can be presented to a user. For example, a comment 520 can be added from a friend that the user should go to a soda shop near an intended destination 504. Advertisement information can be disclosed with the comment, such as picture of the soda shop sign extracted from the profile of a social network member.

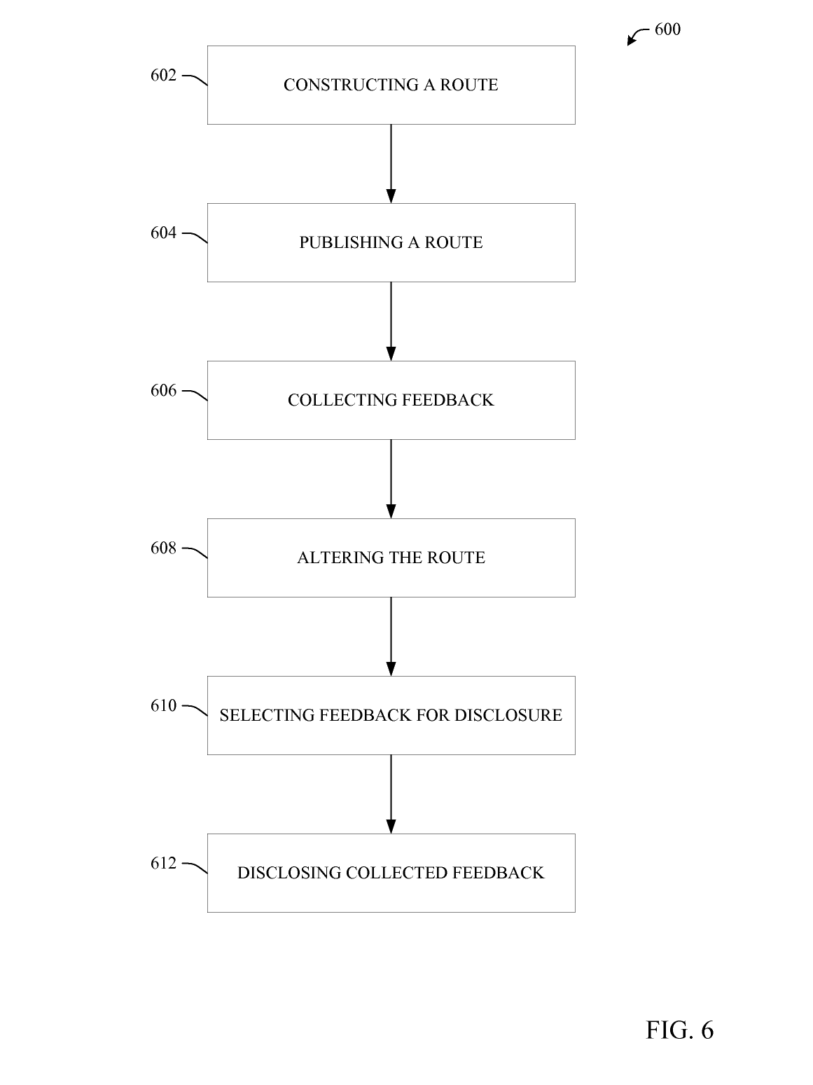

FIG. 6 discloses an example methodology 600 related to route presentation to a user. At block 602, a route can be constructed, commonly based upon social networking information. Various implementations can be used to construct a route. For instance, a route used by a social networking friend can be exported and used; however, more advanced building techniques can be practiced, such as using pre-destination (e.g., pre-destination can include anticipating a user destination based upon previous user conduct without a user explicitly or implicitly disclosing an intended location, such as without a user entering destination information upon a route production device).

At event 604, the route can be published upon a social network profile of a user (e.g., as the user is engaged upon the route, before a user starts upon a route, after a user completes a route, and the like). Publishing can take place globally (e.g., seen by all members), selectively (e.g., to classes of members), specifically (e.g., to named members), and the like. In addition, different amounts of information can be provided to different groups. For example, a route can be disclosed globally while a user position on the route (e.g., through utilization of a global positioning system) can be presented selectively.

Through act 606, feedback related to the published route can be collected. Often times, members of a social network can provide comments related to a route. In one embodiment, a member posts comments directly upon a user's social networking profile. However, feedback can be more subtle—an instant message conversation between two members can talk about the user route, the conversation can be analyzed and feedback can be ascertained from the analysis results.

At action 608, the route is altered as a function of at least a portion of the collected feedback. Detailed evaluation of feedback can take place and modification can occur upon the route based upon the feedback. For instance, the methodology 600 can function upon the presentation 500 of FIG. 5. Based upon comment 512 of FIG. 5 and comment 514 of FIG. 5, the route can be altered. Action 608 allows determinations to be made as to what alterations should take place and implementation of the alterations.

At least some of the feedback used to alter the route can be selected for disclosure at event 610. It is possible a user viewed the route published at event 604, so a route changing can become confusing to the user. Therefore, feedback can be selected that explains to the user why a change was made. Exact feedback can be selected (e.g., verbatim of what a member said) as well as modified feedback (e.g., a synopsis of what a member said). Feedback can include routes taken or planned from other members of the social network. In addition, event 610 can function as a filtering event that does not allow the user to become overburdened with too much information.

Selected feedback can be disclosed to the user as well as the altered route at event 612. Multiple formats can be implemented when disclosing the route or feedback. For instance, the route can be presented visually upon a screen while feedback is disclosed through sound using voices of individuals that made the comments. According to one embodiment, the user selects disclosure formats prior to the disclosure.

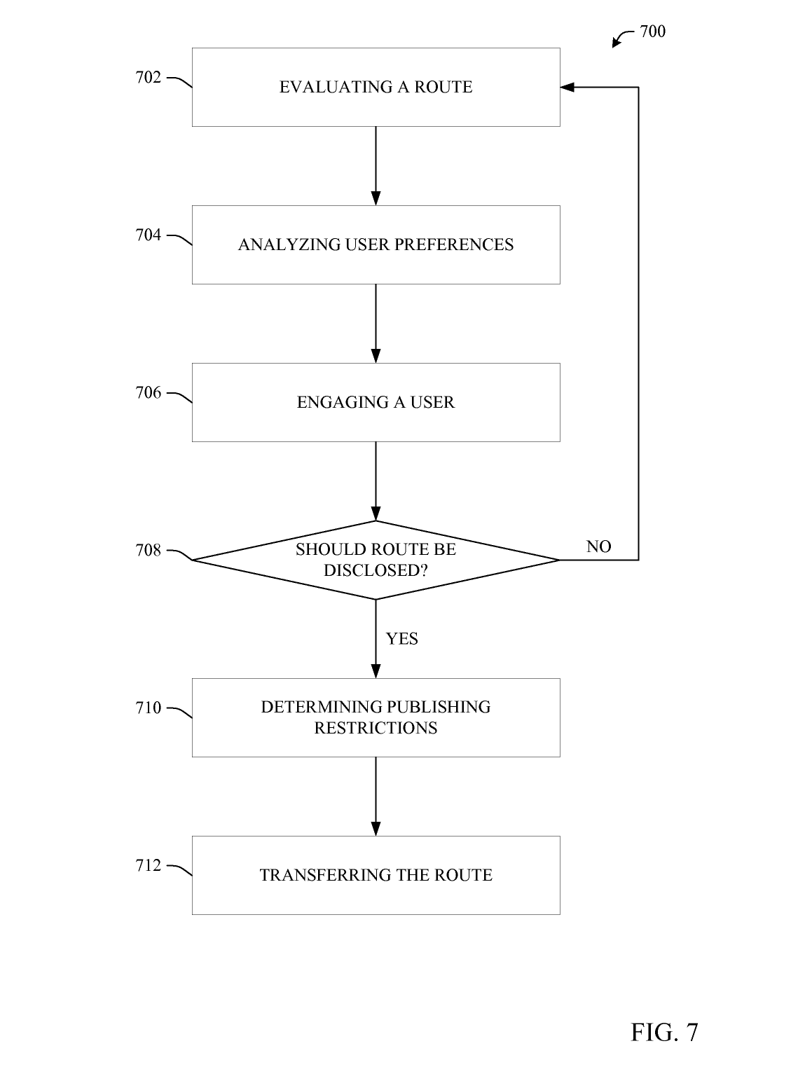

FIG. 7 discloses an example methodology 700 for publishing a route that can be practiced for event 604 of FIG. 6. A route can be evaluated at event 702 to ascertain characteristics of the route. For example, a route can be extremely complex, with a relatively large number of turns. Disclosure of the route upon a personal electronic device can be difficult and evaluation can show that changes to the route should be made.

At event 704, user preferences related to route publication can be analyzed. A user can have a history related to route presentation and the history can be taken into account in route publication. User preferences can range from simple and likely relevant (e.g., if a user commonly allows relatives to view her position along a route) to complex and relatively obscure (e.g., if a user allows friends to know her position during nighttime travel). Additionally, a user can request that the route be published to one social networking site used for personal relationships while not publishing on a supplemental social networking site used for entertainment purposes (e.g., use of a pseudonym).

At event 706, the user can be engaged such that the user can approve of preferences or unknown preferences can be gathered. For example, the user can be presented with a questionnaire concerning route publication where the user can specify parameters (e.g., if the route is to be published, people that can view the route, etc.). However, user engagement can be more passive, such as establishing a time window that a user can set parameters, but not actively seeking out parameter information.

A check 708 determines if a route should be disclosed. Commonly, the check make the determination of data collected at events 702, 704, or 706. If a route should not be disclosed, then the methodology 700 can return to event 702. If a modification takes place upon the route (e.g., the user changes an intended destination) then the events can re-occur. Moreover, if a user changes a preference, then the check 708 can take place again.

If a route is to be disclosed, then a determination on how to publish the route takes place at event 710. For instance, different limitations can exist in relation to the route. A user can specify that the route can be disclosed, but his position along the route is not to be disclosed. Moreover, if the route is detailed, but a social networking site has detail disclosure limitations (e.g., a file size limit is imposed for route disclosure), then disclosure modification should be implemented.

The route can be transferred to an auxiliary party at event 712. Publishing the route enables the social networking site to post the route on designated profiles. For instance, the route can be transferred with instructions related to determinations made at event 710. In addition, different protective features can be implemented, such as encrypting the route and providing signal data to the social networking site relevant to the user's position along the route.

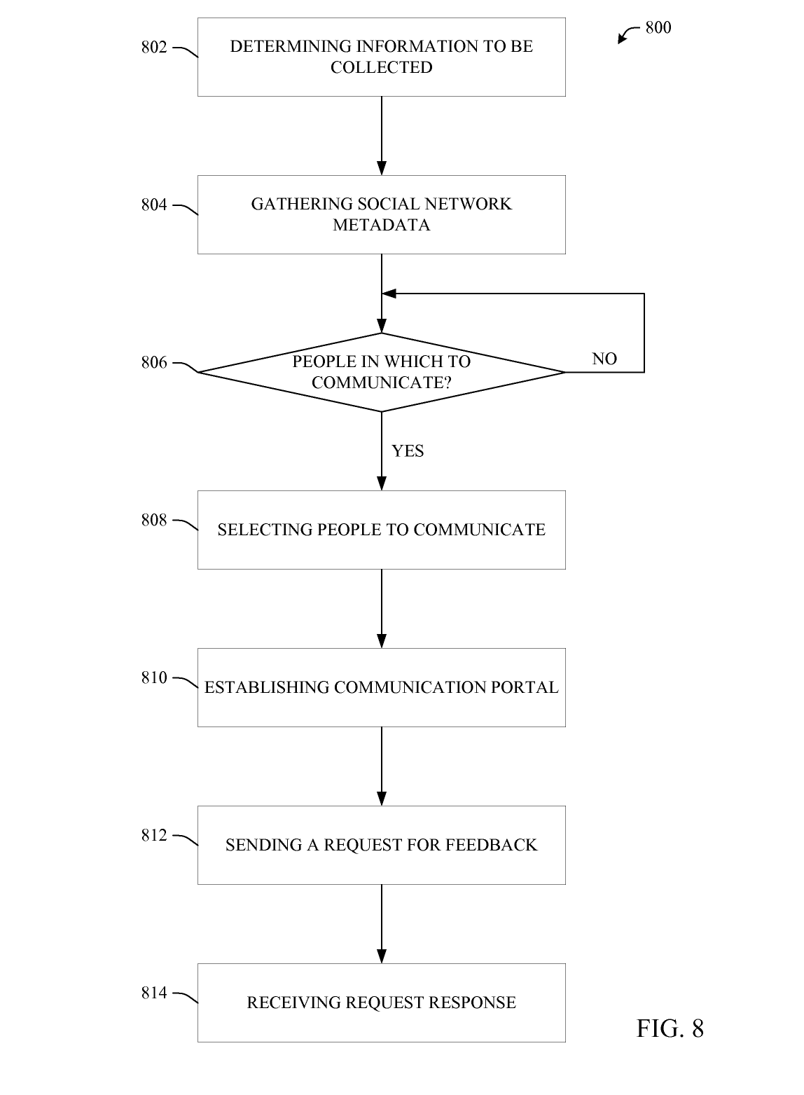

FIG. 8 disclosed an example methodology 800 for collecting feedback information that can be practiced for act 606 of FIG. 6. A determination on what information should be collected takes place at action 802. Previous history can be used to make the determination—a user frequently requests a route change based on comments on friends, but rarely requests route alteration based upon previous journeys of friends.

Social network metadata can be gathered at act 804. Various amounts of information can be gathered, such as friends that are online, friends that have access to a published route, and the like. Moreover, social network site maintenance statistics, cost information, etc. can be taken into account when collecting information relevant to the social network.

Verification 806 can be used to determine if people on the social network can be engaged in communication. For example, a user can recently have created a social network profile, but not populated the profile with friend relationships. Therefore, it is unlikely that there are individuals that can provide route feedback. If people are not able to communicate, then the verification can loop back continuously checking if a person becomes available.

If people are to be engaged, then selection of appropriate people occurs at action 808. This can relate to user preferences at event 704 of FIG. 7 as well as through other embodiments. In addition to selecting people, restrictions can be determined upon selected people. For example, a close friend can provide uncensored information while a relative stranger (e.g., friend through a friend relationship) can have feedback censored for profanity.

At block 810, a communication portal is established that allows selected people to provide feedback. The communication portal can be a link between a social networking site host as well as a device running the methodology 800. In a different configuration, the device running the methodology 800 can connect to at least one personal electronic device, such a member's cellular telephone—members can provide feedback through use of the site, but directly from the telephone.

A specific request for feedback can be set at event 812. The request can be sent through the established communication portal and convey information that increases a likelihood of feedback as well as quality of feedback. Example request contents include the route, rationale for taking the route, information used to produce the route, and the like.

A response to the request can be received at action 814. In addition to receiving the request response, an evaluation of the response can take place. Results of the evaluation can be used to determine alterations to be made upon a route. Additionally, various security features can implement with receiving the request response, such as determining if feedback include unsolicited advertisements for products.

For purposes of simplicity of explanation, methodologies that can be implemented in accordance with the disclosed subject matter were shown and described as a series of blocks. However, it is to be understood and appreciated that the claimed subject matter is not limited by the order of the blocks, as some blocks can occur in different orders and/or concurrently with other blocks from what is depicted and described herein. Moreover, not all illustrated blocks can be required to implement the methodologies described hereinafter. Additionally, it should be further appreciated that the methodologies disclosed throughout this specification are capable of being stored on an article of manufacture to facilitate transporting and transferring such methodologies to computers. The term article of manufacture, as used, is intended to encompass a computer program accessible from any computer-readable device, carrier, or media.

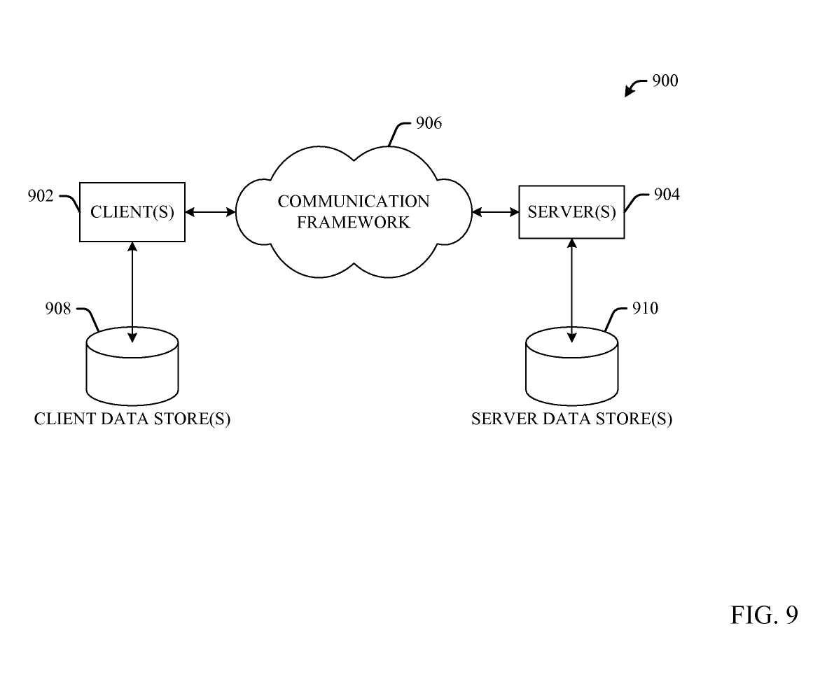

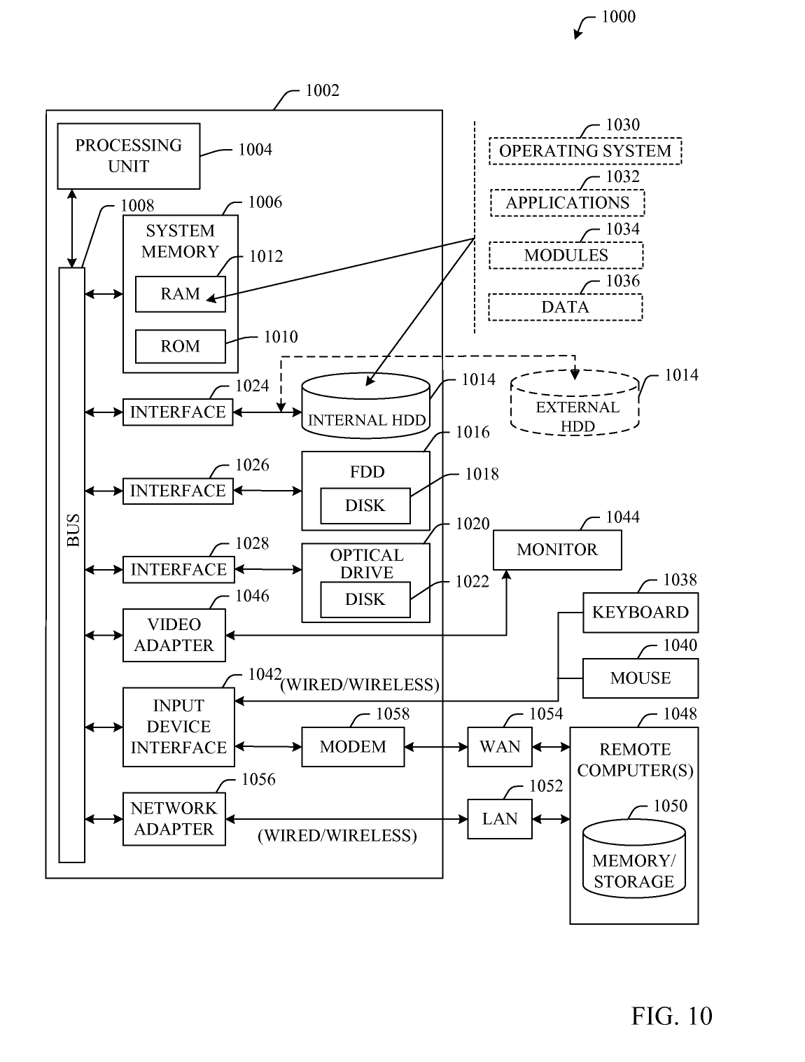

In order to provide a context for the various aspects of the disclosed subject matter, FIGS. 9 and 10 as well as the following discussion are intended to provide a brief, general description of a suitable environment in which the various aspects of the disclosed subject matter can be implemented. While the subject matter has been described above in the general context of computer-executable instructions of a program that runs on one or more computers, those skilled in the art will recognize that the subject matter described herein also can be implemented in combination with other program modules. Generally, program modules include routines, programs, components, data structures, etc. that perform particular tasks and/or implement particular abstract data types. Moreover, those skilled in the art will appreciate that the inventive methods can be practiced with other computer system configurations, including single-processor, multiprocessor or multi-core processor computer systems, mini-computing devices, mainframe computers, as well as personal computers, hand-held computing devices (e.g., personal digital assistant (PDA), phone, watch . . . ), microprocessor-based or programmable consumer or industrial electronics, and the like. The illustrated aspects can also be practiced in distributed computing environments where tasks are performed by remote processing devices that are linked through a communications network. However, some, if not all aspects of the claimed subject matter can be practiced on stand-alone computers. In a distributed computing environment, program modules can be located in both local and remote memory storage devices.

Referring now to FIG. 9, there is illustrated a schematic block diagram of a computing environment 900 in accordance with the subject specification. The system 900 includes one or more client(s) 902. The client(s) 902 can be hardware and/or software (e.g., threads, processes, computing devices). The client(s) 902 can house cookie(s) and/or associated contextual information by employing the specification, for example.

The system 900 also includes one or more server(s) 904. The server(s) 904 can also be hardware and/or software (e.g., threads, processes, computing devices). The servers 904 can house threads to perform transformations by employing the specification, for example. One possible communication between a client 902 and a server 904 can be in the form of a data packet adapted to be transmitted between two or more computer processes. The data packet can include a cookie and/or associated contextual information, for example. The system 900 includes a communication framework 906 (e.g., a global communication network such as the Internet) that can be employed to facilitate communications between the client(s) 902 and the server(s) 904.

Communications can be facilitated via a wired (including optical fiber) and/or wireless technology. The client(s) 902 are operatively connected to one or more client data store(s) 908 that can be employed to store information local to the client(s) 902 (e.g., cookie(s) and/or associated contextual information). Similarly, the server(s) 904 are operatively connected to one or more server data store(s) 910 that can be employed to store information local to the servers 904.

Referring now to FIG. 10, there is illustrated a block diagram of a computer operable to execute the disclosed architecture. In order to provide additional context for various aspects of the subject specification, FIG. 10 and the following discussion are intended to provide a brief, general description of a suitable computing environment 1000 in which the various aspects of the specification can be implemented. While the specification has been described above in the general context of computer-executable instructions that can run on one or more computers, those skilled in the art will recognize that the specification also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the specification can also be practiced in distributed computing environments where certain tasks are performed by remote processing devices that are linked through a communications network. In a distributed computing environment, program modules can be located in both local and remote memory storage devices.

A computer typically includes a variety of computer-readable media. Computer-readable media can be any available media that can be accessed by the computer and includes both volatile and nonvolatile media, removable and non-removable media. By way of example, and not limitation, computer-readable media can comprise computer storage media and communication media. Computer storage media includes volatile and nonvolatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD-ROM, digital versatile disk (DVD) or other optical disk storage, magnetic cassettes, magnetic tape, magnetic disk storage or other magnetic storage devices, or any other medium which can be used to store the desired information and which can be accessed by the computer.

Communication media typically embodies computer-readable instructions, data structures, program modules or other data in a modulated data signal such as a carrier wave or other transport mechanism, and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

With reference again to FIG. 10, the example environment 1000 for implementing various aspects of the specification includes a computer 1002, the computer 1002 including a processing unit 1004, a system memory 1006 and a system bus 1008. The system bus 1008 couples system components including, but not limited to, the system memory 1006 to the processing unit 1004. The processing unit 1004 can be any of various commercially available processors. Dual microprocessors and other multi-processor architectures can also be employed as the processing unit 1004.

The system bus 1008 can be any of several types of bus structure that can further interconnect to a memory bus (with or without a memory controller), a peripheral bus, and a local bus using any of a variety of commercially available bus architectures. The system memory 1006 includes read-only memory (ROM) 1010 and random access memory (RAM) 1012. A basic input/output system (BIOS) is stored in a non-volatile memory 1010 such as ROM, EPROM, EEPROM, which BIOS contains the basic routines that help to transfer information between elements within the computer 1002, such as during start-up. The RAM 1012 can also include a high-speed RAM such as static RAM for caching data.

The computer 1002 further includes an internal hard disk drive (HDD) 1014 (e.g., EIDE, SATA), which internal hard disk drive 1014 can also be configured for external use in a suitable chassis (not shown), a magnetic floppy disk drive (FDD) 1016, (e.g., to read from or write to a removable diskette 1018) and an optical disk drive 1020, (e.g., reading a CD-ROM disk 1022 or, to read from or write to other high capacity optical media such as the DVD). The hard disk drive 1014, magnetic disk drive 1016 and optical disk drive 1020 can be connected to the system bus 1008 by a hard disk drive interface 1024, a magnetic disk drive interface 1026 and an optical drive interface 1028, respectively. The interface 1024 for external drive implementations includes at least one or both of Universal Serial Bus (USB) and IEEE 1394 interface technologies. Other external drive connection technologies are within contemplation of the subject specification.

The drives and their associated computer-readable media provide nonvolatile storage of data, data structures, computer-executable instructions, and so forth. For the computer 1002, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, can also be used in the example operating environment, and further, that any such media can contain computer-executable instructions for performing the methods of the specification.

A number of program modules can be stored in the drives and RAM 1012, including an operating system 1030, one or more application programs 1032, other program modules 1034 and program data 1036. All or portions of the operating system, applications, modules, and/or data can also be cached in the RAM 1012. It is appreciated that the specification can be implemented with various commercially available operating systems or combinations of operating systems.

A user can enter commands and information into the computer 1002 through one or more wired/wireless input devices, e.g., a keyboard 1038 and a pointing device, such as a mouse 1040. Other input devices (not shown) can include a microphone, an IR remote control, a joystick, a game pad, a stylus pen, touch screen, or the like. These and other input devices are often connected to the processing unit 1004 through an input device interface 1042 that is coupled to the system bus 1008, but can be connected by other interfaces, such as a parallel port, an IEEE 1394 serial port, a game port, a USB port, an IR interface, etc.

A monitor 1044 or other type of display device is also connected to the system bus 1008 via an interface, such as a video adapter 1046. In addition to the monitor 1044, a computer typically includes other peripheral output devices (not shown), such as speakers, printers, etc.

The computer 1002 can operate in a networked environment using logical connections via wired and/or wireless communications to one or more remote computers, such as a remote computer(s) 1048. The remote computer(s) 1048 can be a workstation, a server computer, a router, a personal computer, portable computer, microprocessor-based entertainment appliance, a peer device or other common network node, and typically includes many or all of the elements described relative to the computer 1002, although, for purposes of brevity, only a memory/storage device 1050 is illustrated. The logical connections depicted include wired/wireless connectivity to a local area network (LAN) 1052 and/or larger networks, e.g., a wide area network (WAN) 1054. Such LAN and WAN networking environments are commonplace in offices and companies, and facilitate enterprise-wide computer networks, such as intranets, all of which can connect to a global communications network, e.g., the Internet.

When used in a LAN networking environment, the computer 1002 is connected to the local network 1052 through a wired and/or wireless communication network interface or adapter 1056. The adapter 1056 can facilitate wired or wireless communication to the LAN 1052, which can also include a wireless access point disposed thereon for communicating with the wireless adapter 1056.

When used in a WAN networking environment, the computer 1002 can include a modem 1058, or is connected to a communications server on the WAN 1054, or has other means for establishing communications over the WAN 1054, such as by way of the Internet. The modem 1058, which can be internal or external and a wired or wireless device, is connected to the system bus 1008 via the serial port interface 1042. In a networked environment, program modules depicted relative to the computer 1002, or portions thereof, can be stored in the remote memory/storage device 1050. It will be appreciated that the network connections shown are example and other means of establishing a communications link between the computers can be used.

The computer 1002 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11 (a, b, g, etc.) to provide secure, reliable, fast wireless connectivity. A Wi-Fi network can be used to connect computers to each other, to the Internet, and to wired networks (which use IEEE 802.3 or Ethernet). Wi-Fi networks operate in the unlicensed 2.4 and 5 GHz radio bands, at an 11 Mbps (802.11a) or 54 Mbps (802.11b) data rate, for example, or with products that contain both bands (dual band), so the networks can provide real-world performance similar to the basic 10 BaseT wired Ethernet networks used in many offices.

The aforementioned systems have been described with respect to interaction among several components. It should be appreciated that such systems and components can include those components or sub-components specified therein, some of the specified components or sub-components, and/or additional components. Sub-components can also be implemented as components communicatively coupled to other components rather than included within parent components. Additionally, it should be noted that one or more components could be combined into a single component providing aggregate functionality. The components could also interact with one or more other components not specifically described herein but known by those of skill in the art.

What has been described above includes examples of the subject specification. It is, of course, not possible to describe every conceivable combination of components or methodologies for purposes of describing the subject specification, but one of ordinary skill in the art can recognize that many further combinations and permutations of the subject specification are possible. Accordingly, the subject specification is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. A system, comprising:
an obtainment component that collects information that concerns a user upon a social network; and
a fabrication component that produces a route based at least in part upon the collected social network information of the user.

2. The system of claim 1, the fabrication component produces the route in order to increase an amount of content for placement upon the social network.

3. The system of claim 1, further comprising a transmission component that emits metadata of the route to a host of the social network, the host posts at least a portion of the metadata upon the social network.

4. The system of claim 1, the obtainment component collects information created by an individual associated with the social network that concerns the route.

5. The system of claim 4, further comprising an alteration component that modifies the route based upon the gathered information by an individual associated with the social network, the fabrication component produces the modified route.

6. The system of claim 5, the alteration component modifies the route to produce an improved route.

7. The system of claim 1, further comprising an analysis component that evaluates the collected information, the evaluation results are used by the fabrication component to produce the route.

8. The system of claim 1, further comprising a content component that gathers data associated with the route while the user travels along the route.

9. The system of claim 8, further comprising a choice component that selects at least a portion of gathered data to be posted on a profile of the user, the profile is associated with the social network.

10. The system of claim 9, further comprising an update component that instructs that at least a portion of selected gathered data be posted upon the profile of the user.

11. The system of claim 1, further comprising a transaction component that performs a reward function based upon route production or information collection.

12. The system of claim 1, further comprising a disclosure component that presents the route to the user.

13. The system of claim 1, the fabrication component produces a route based upon travel of at least one social network contact of the user.

14. A method, comprising:
publishing a route upon a social network profile of a user; and
collecting feedback that concerns the route from at least one member of the social network.

15. The method of claim 14, further comprising altering the route as a function of the collected feedback.

16. The method of claim 14, further comprising disclosing at least a portion of the collected feedback to the user.

17. The method of claim 16, further comprising selecting the portion of the collected feedback that is disclosed to the user.

18. The method of claim 14, further comprising constructing the route that is published.

19. The method of claim 14, at least one member of the social network is associated with the social network profile of the user or publishing a route upon a social network profile of a user takes place as the user is engaged upon the route.

20. A system, comprising:
means for collecting feedback that concerns a route from members of the social network; and
means for altering the route as a function of the collected feedback.
